(19) United States
(12) Patent Application Publication
(10) Pub. No.: US 2011/0135209 A1
(43) Pub. Date: Jun. 9, 2011

(54) BUSINESS DOCUMENT PROCESSOR

(75) Inventor: Mitsuharu Oba, Tokyo (JP)

(73) Assignee: HITACHI SOLUTIONS, LTD., Tokyo (JP)

(21) Appl. No.: 13/057,207

(22) PCT Filed: Dec. 15, 2009
(86) PCT No.: PCT/JP2009/006889

§ 371 Date: Feb. 2, 2011

(30) Foreign Application Priority Data
Dec. 26, 2008 (JP) 2008-335216

(51) Int. Cl. G06K 9/62

(52) U.S. Cl. 382/224

(57) ABSTRACT

A seal impression is removed while keeping character string information when applying OCR to a business document stored in grayscale, even if the character string and the seal impression overlap with each other. The character string that overlaps is extrapolated by matching a character string present near the seal impression against a database. First, a seal impression region in a document inputted in grayscale is removed. Next, character information that is present near the removed seal impression region and of which a portion of the characters is unclear due to the seal impression region is extracted. Then, an attribute of the extracted seal impression related information is identified, a customer database storing character string candidates containing customer information is referred to, and based on the seal impression related information classified by attribute, the character string that overlaps with the seal impression region and that is thus unclear is extrapolated.

### TECHNICAL FIELD

The present invention relates to a business document processor and to, for example, a technique for removing a seal impression within a business document.

### BACKGROUND ART

With respect to the enormous amounts of paper business documents archived within organizations, there has been an interest in recent years in achieving improvements in searchability, safe storage of paper documents, and sharing of knowledge through character recognition via scanning and OCR, and managing document data with document management systems.

While OCR in its current state has high character string recognition accuracy for documents free of noise, when, for example, a seal image such as that of a company seal overlaps with a character string, there is a problem in that that portion would be erroneously recognized. If erroneously recognized, not only would the character information of that portion be unobtainable, but nonsensical character information would become and remain as noise, and impede subsequent searches. Seal images found in business documents are characteristic in that they are often affixed in such a manner that they overlap with information regarding customers such as customer name, name of representative of customer, and the like. Such pieces of information are often vital in identifying those documents. Thus, if such information cannot be recognized, these documents will not be returned during searches, and one would have to check all registered document data. For this reason, when applying OCR, it is necessary that character strings that overlap with seal impressions also be recognized with a high degree of accuracy.

In order to improve the recognition accuracy of such OCR, there is proposed a method for separating a seal impression that overlaps with a character string. For example, in Patent Literature 1 and Patent Literature 2, there are proposed techniques for recognizing and removing a seal impression, discerning it from text using the difference between the color of the seal impression and the color of the text in the document. Thus, even if the text and the seal impression overlap with each other, it is possible to remove only the seal impression while keeping the overlapping text.

In addition, in Patent Literature 3, there is proposed a technique for recognizing and removing seal impressions taking advantage of the fact that the contours of seal impressions often take on the form of regular polygons. Thus, in cases where the text and the seal impression overlap with each other, it is possible to prevent erroneous recognition of OCR by removing the seal impression and the character strings that overlap with the seal impression.

### CITATION LIST

### Patent Literature

PTL 1: Japanese Patent Publication (Kokai) No. 2008-176521 A
PTL 2: Japanese Patent Publication (Kokai) No. 2006-309781 A
PTL 3: Japanese Patent Publication (Kokai) No. 9-229646 A (1997)

### SUMMARY OF INVENTION

### Technical Problem

However, since business documents already archived electronically are sometimes stored in grayscale, the techniques of Patent Literature 1 and 2, which are techniques for recognizing seal impressions in color, are inapplicable. FIG. 2 is a diagram showing an example of a business document scanned in grayscale, where a company seal is affixed to the upper right in such a manner as to overlap with a portion of the company information. Since this document is scanned in grayscale, even if the techniques of Patent Literature 1 and 2 for recognizing seal impressions using color information were to be applied, it would not be possible to recognize the portion where the seal impression is affixed.

In addition, FIG. 3 is a diagram showing a result where the seal impression in the business document in FIG. 2 is removed with the technique of Patent Literature 3, and the remaining characters are recognized through OCR. When the seal impression is removed with the technique of Patent Literature 3, overlapping character strings are also removed along with the seal impression as shown in FIG. 3. Therefore, the removed character string information is lost. In addition, because the text is partially left, there is a possibility that the remaining text may later become noise during searches.

The present invention is made in view of such circumstances, and provides a technique for removing only a seal impression while keeping character string information when applying OCR to a business document stored in grayscale even in cases where character strings and seal impressions overlap with each other.

### Solution to Problem

In order to solve the problems above, a business document processor according to the present invention comprises: a seal impression detection processing portion that detects a seal impression region in a business document inputted in grayscale and removes the seal impression region from the business document; a seal impression related information extraction processing portion that extracts as seal impression related information (for example, information relating to a customer) character information that exists near the removed seal impression region in the business document, from which the seal impression region has been removed, where a portion of the characters is unclear due to the seal impression region; an attribute classification processing portion that identifies attributes of the seal impression related information that has been extracted; and a character extrapolation processing portion that refers to a character string candidate database storing character string candidates (for example, a customer database storing customer information) and extrapolates, based on the seal impression related information that has been classified by the attributes, a character string that overlaps with the seal impression region and that is thus unclear.

In addition, the character extrapolation processing portion substitutes into the portion that is unclear due to the seal impression region the character string obtained by extrapolation, and registers the business document data, into which the character string has been substituted, in a document database in a pair with the business document inputted in grayscale.

The business document processor may further comprise a display processing portion that displays on a display portion the business document data into which the character string has been substituted. In this case, if there are a plurality of character string candidates that may be substituted, the display processing portion displays on the display portion a plurality of business document data into which the plurality of candidates have been substituted, and the character extrapolation processing portion registers in the document database, of the plurality of business document data, the business document data that is selected by a user.

In addition, the character extrapolation processing portion may calculate the degree of match between information stored in the character string candidate database and the seal impression related information that has been classified by attribute, and treat the information stored in the character string candidate database as a character string candidate for substitution when the degree of match exceeds a predetermined value. On the other hand, if the degree of match is at or below a predetermined value, processing may be terminated without substituting any characters into the seal impression region.

Further features of the present invention will become apparent from the best mode for carrying out the invention provided below and the accompanying drawings.

### Advantageous Effects of Invention

According to the present invention, it becomes possible to recognize documents inputted in grayscale even if character strings found in the documents overlap with seal impressions such as those of company seals and the like. Thus, searchability for business documents improves, and the effectiveness of document management systems is further enhanced.

### BRIEF DESCRIPTION OF DRAWINGS

FIG. 1 is a functional block diagram schematically showing the configuration of a business document processor according to an embodiment of the present invention.

FIG. 2 is a diagram showing an example of grayscale image data stored in the data memory shown in FIG. 1.

FIG. 3 is a diagram showing an example of OCR result data stored in the data memory shown in FIG. 1.

FIG. 4A is diagram (1) illustrating a process of seal impression related data stored in the data memory shown in FIG. 1.

FIG. 4B is diagram (2) illustrating a process of seal impression related data stored in the data memory shown in FIG. 1.

FIG. 4C is diagram (3) illustrating a process of seal impression related data stored in the data memory shown in FIG. 1.

FIG. 4D is diagram (4) illustrating a process of seal impression related data stored in the data memory shown in FIG. 1.

FIG. 4E is diagram (5) illustrating a process of seal impression related data stored in the data memory shown in FIG. 1.

FIG. 5A is a diagram showing an example of document data contained in the document database shown in FIG. 1.

FIG. 5B is a diagram showing an example of document data contained in the document database shown in FIG. 1.

FIG. 6 is a diagram showing an example of customer data contained in the customer database shown in FIG. 1.

FIG. 7 is a diagram showing an example of attribute data contained in the attribute database shown in FIG. 1.

FIG. 8 is a flowchart illustrating a process with respect to a business document processor according to an embodiment of the present invention.

FIG. 9 is a flowchart illustrating in detail a process (step S805) by a character substitution processing portion of a business document processing program.

FIG. 10 is a diagram showing an example of a confirmation screen showing a result where character strings that were missing due to a seal impression have been substituted.

### DESCRIPTION OF EMBODIMENTS

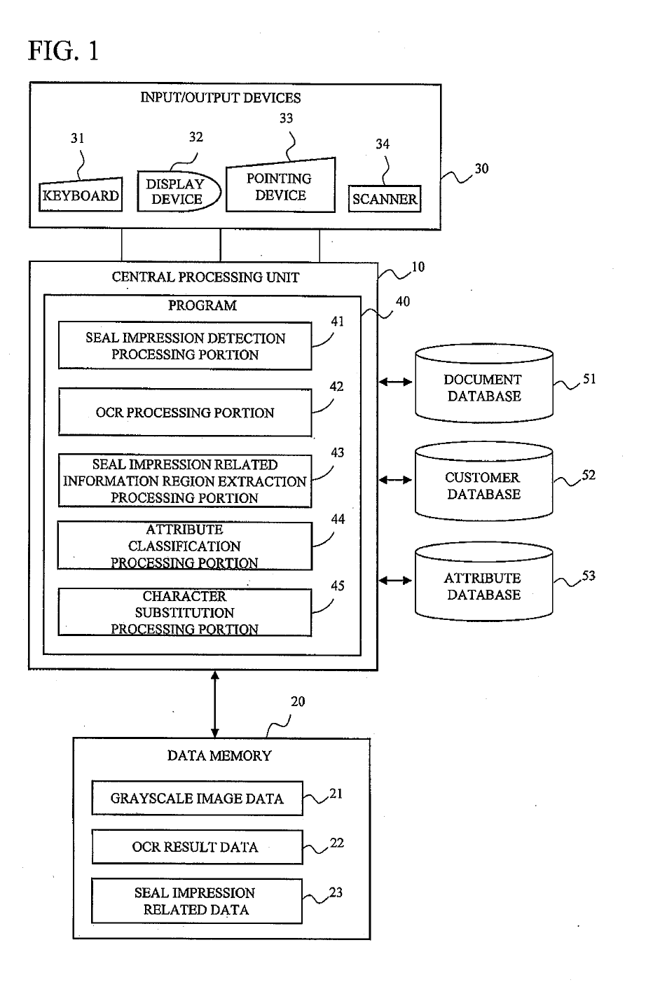

Best modes for carrying out a business document processor of the present invention are described in detail below with reference to the accompanying drawings. FIGS. 1 to 10 are diagrams showing exemplary embodiments of the present invention. In these diagrams, it is assumed that parts with like numerals represent like parts, and that their basic configuration and operation are alike. It is noted that the devices, methods and the like used in the embodiments of the present invention are merely examples, and the present invention is naturally and by no means limited thereto.

### <Configuration of Business Document Processor>

FIG. 1 is a functional block diagram schematically showing the configuration of a business document processor according to an embodiment of the present invention. This business document processor comprises: a document database 51 storing business documents relating to transactions with customers and the like, as well as indices constructed with respect thereto; a customer database 52 storing customer information, including company names, addresses, main telephone numbers and the like of customers, as well as indices constructed with respect thereto; an attribute database 53 storing definition data of character string attributes; input/output devices 30 for inputting/outputting data; a central processing unit 10 that performs required computation processing, control processing, and the like; a program memory 40 that stores programs that are necessary for the processing at the central processing unit 10; and a data memory 20 that stores data that are necessary for the processing at the central processing unit 10.

The input/output devices 30 comprise: an output portion comprising a display device 32 for displaying data, a printer (not shown), and the like; and an input portion comprising a keyboard 31 for performing such operations as menu selection with respect to displayed data, a pointing device 33 such as a mouse, a scanner 34 for scanning documents, and the like.

The program memory 40 comprises: a seal impression detection processing portion 41 that detects a seal impression, such as that of a company seal and the like, that is present in a document; an OCR processing portion 42 that recognizes characters within a document; a seal impression related information region extraction processing portion 43 that cuts out a character string block present in the periphery of a seal impression; an attribute classification processing portion 44 that classifies an attribute of a character string within the character string block; and a character substitution processing portion 45. It is noted that each processing portion is stored in the program memory 40 as program code, and each processing portion is realized through execution of the respective program code by the central processing unit 10.

The data memory 20 comprises: grayscale image data 21 obtained by scanning a paper document in grayscale; OCR result data 22 that is generated by applying OCR with respect to the grayscale image data 21; and seal impression related data 23 in which is stored information on a character string block near a seal impression region within the OCR result data 22.

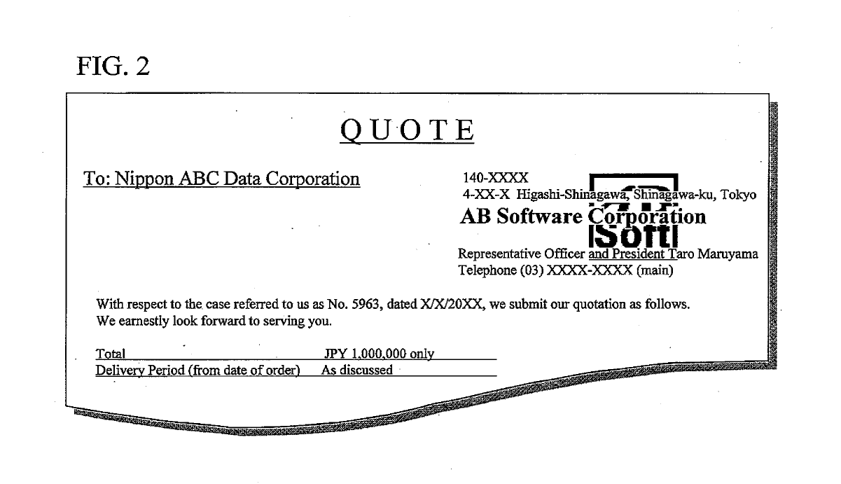

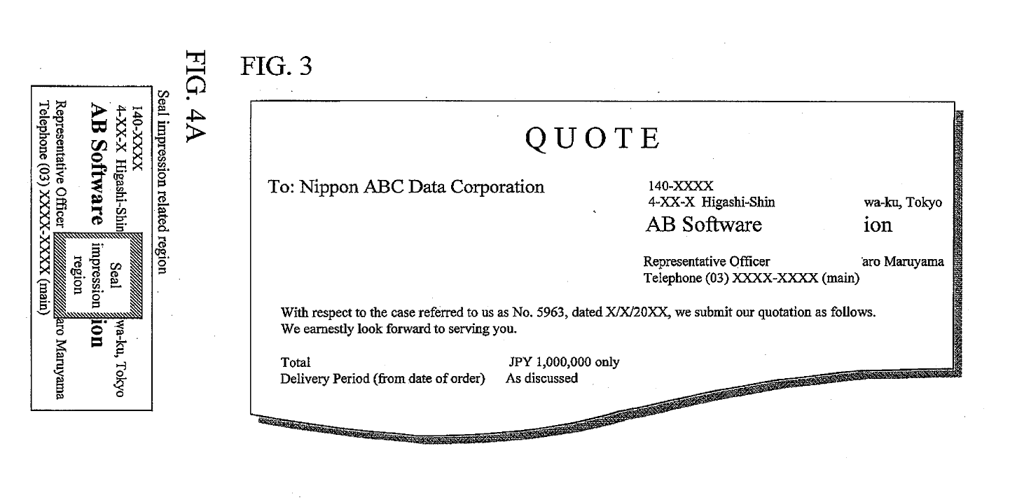

FIG. 2 is a diagram showing an example of the grayscale image data 21 included in the data memory 20. To the upper right, there is affixed a company seal in such a manner that it overlaps with part of the company name. In the original, the seal impression is in red and the text color is black. Thus, the colors of the seal impression and the text are different. However, because the document is scanned in grayscale, the text and the seal impression are in the same color. With respect to such data, the seal impression and the text cannot be separated by applying the techniques of Patent Literature 1 and 2 which recognize and separate a seal impression with color. In addition, if the technique of Patent Literature 3 were applied, because the seal impression and the text cannot be discerned from each other, application of this technique to the image data in FIG. 2 would result in the seal impression and the character string overlapping with the seal impression both being removed as in FIG. 3.

FIG. 3 is a diagram showing an example of the OCR result data 22 included in the data memory 20. The interior of the region in which the seal impression is affixed is removed, including character strings, by a seal impression removing technique. In addition, by applying OCR, bold settings, underlines, and the like, of text are removed, and the font is unified. This is because, in general, OCR is incapable of recognizing underlines, bold settings, and the like.

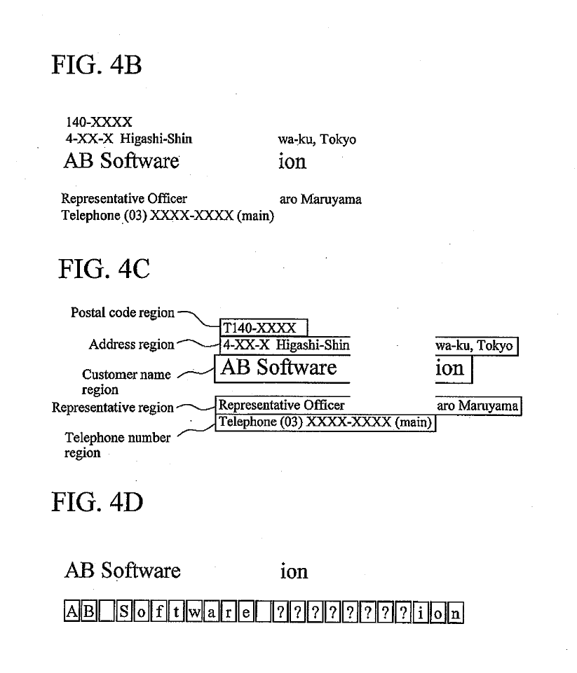

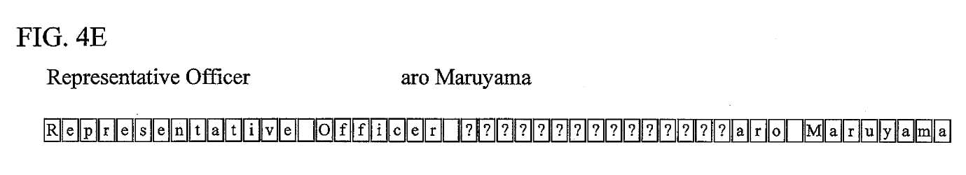

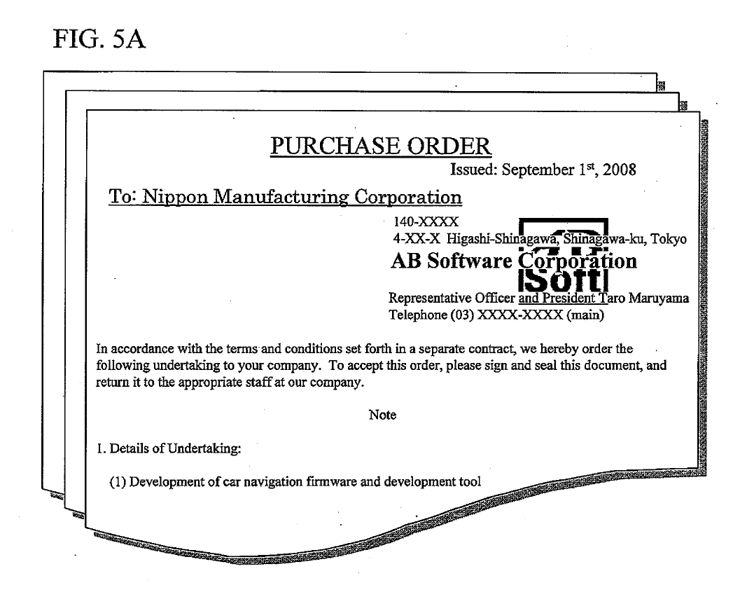

FIGS. 4A through 4E are diagrams showing examples of the seal impression related data 23 included in the data memory 20. They show data which are cutouts of a region near where the removed seal impression was present in the OCR result data 22. FIG. 4A is a diagram explicitly showing a seal impression related region and a seal impression region. FIG. 4B is a diagram that is a cutout of just the seal impression related region from the OCR result data 22. FIG. 4C is a diagram showing a state where corresponding attributes are assigned to the respective character strings included in the seal impression related data 23. FIGS. 4D and 4E are diagrams showing examples in which, with respect to the character strings included in the seal impression related data 23, the number of characters missing due to the seal impression is estimated by analyzing the character spacing. Since the font size of the character strings can be identified through an OCR process, the number of characters that should be present can be ascertained from the size of the space with unknown characters.

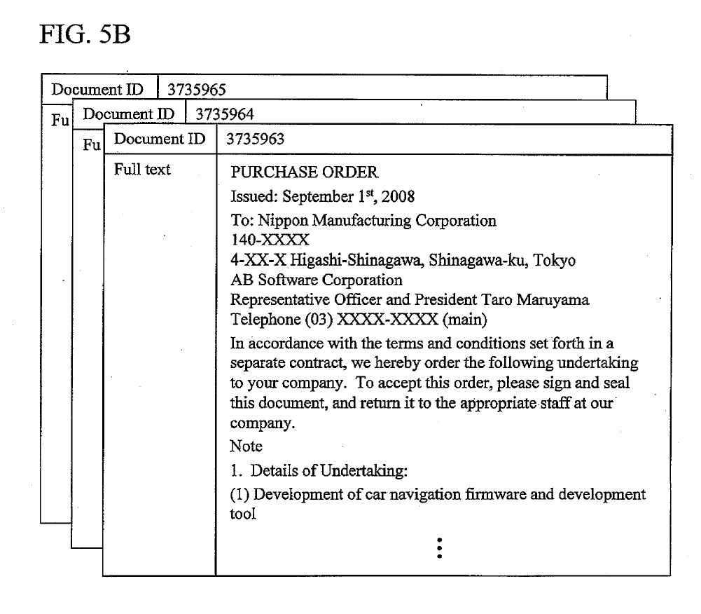

FIGS. 5A and 5B are diagrams showing examples of the document data included in the document database 51. The document data comprises a scanned business document such as that shown in FIG. 5A, and index data (data that is registered after being subjected to seal impression recognition processing, where appropriate characters are substituted into the seal impression portion) such as that shown in FIG. 5B. Uniquely identifiable document IDs are assigned to the document data. In addition, full text information is available, thereby enabling full text searches.

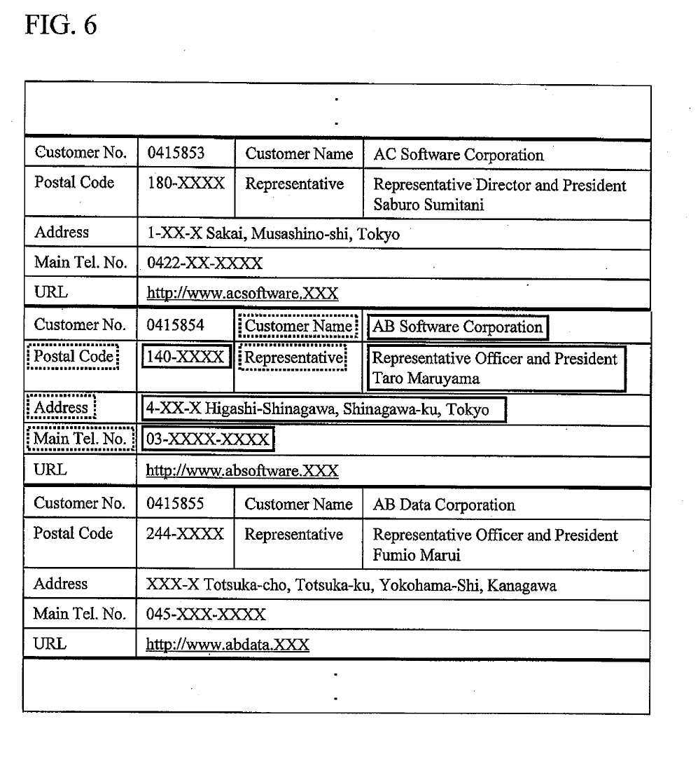

FIG. 6 is a diagram showing an example of data relating to a customer and that is included in the customer database 52. Such information as customer number, which uniquely identifies a customer, customer name, address, and the like, are stored.

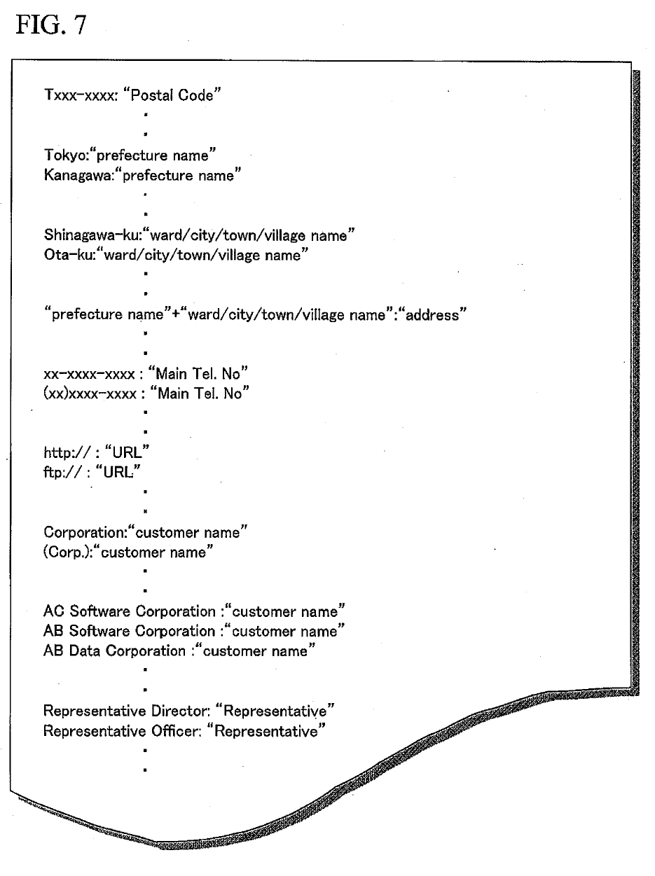

FIG. 7 is a diagram showing an example of attribute definition data included in the attribute database 53. In FIG. 7, there are provided definitions for classifying character strings into postal code, prefecture name, ward/city/town/village name, and the like. In the example in FIG. 7, they are expressed in the format “character pattern: attribute” on one line. For example, “Txxx-xxxx:‘postal code’” would signify that if there were an occurrence of “Txxx-xxxx” (where x is an arbitrary number from 0 to 9) within a character string, the attribute of that character string would be postal code.

### <Processing at Business Document Processor>

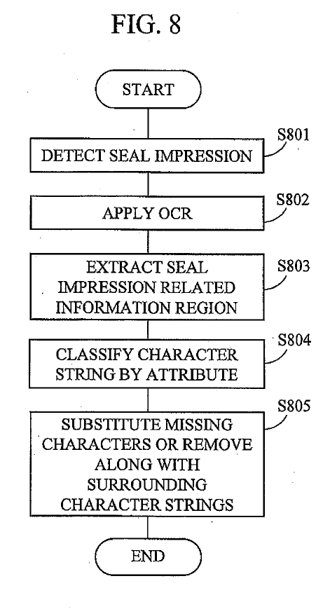

Next, processing performed at a business document processor having the configuration discussed above is described. FIG. 8 is a flowchart schematically showing the flow of processing by the business document processor.

In FIG. 8, first, using the seal impression detection processing portion 41, the central processing unit 10 detects and removes a seal impression in and from a business document that is inputted by the scanner 34 (step S801). Next, the OCR processing portion 42 applies OCR to the business document and recognizes the character information within the document (step S802). In addition, the seal impression related information region extraction processing portion 43 cuts out a region near where the seal impression was present in the OCR result data 22 and extracts the seal impression related data 23 (step S803). Subsequently, the attribute classification processing portion 44 determines the attribute of a character string present in the seal impression related data 23 (step S804). Finally, the character substitution processing portion 45 matches the seal impression related data 23 against each customer data stored in the customer database 52, and extrapolates the relevant customer (step S805). The processes in the respective steps are described in detail below.

### <Seal Impression Detection Process>

Details of the process in FIG. 8 of detecting the seal impression included in the business document (step S801) are described below.

First, the seal impression detection processing portion 41 reads the grayscale image data 21 obtained by scanning the business document in grayscale, and searches for the region of the seal impression within the grayscale image data 21. In so doing, the seal impression is searched for using such conventional techniques as those of Patent Literature 3 and the like. In addition, after the seal impression search, the seal impression detection processing portion 41 removes a polygonal region including the contour of that seal impression. Here, with the technique of Patent Literature 3, since the seal impression and character strings cannot be recognized separately, when the seal impression region is removed, the character strings are removed together as well. The character strings removed at this point are later substituted by being extrapolated by the character substitution processing portion 45 from the surrounding character strings as will be described later.

### <Seal Impression Related Information Region Extraction Process>

Next, details of the process in FIG. 8 of extracting the region that includes customer information and that is included in the business document (step S803) are described below. In this process, a process is performed where a seal impression region and a character string block, which relates to a customer and is present near the seal impression region, such as those shown in FIG. 4B are cut out from the OCR result data 22 such as that shown in FIG. 3.

First, the seal impression related information region extraction processing portion 43 sets the seal impression region (the region at which the seal impression was detected through the seal impression detection process) as an initial value of a seal impression related information region, and enlarges the seal impression related information region so as to include the character strings present nearby. Specifically, the seal impression related information region extraction processing portion 43 searches for character strings surrounding the seal impression related information region. For example, since it is possible to identify, through an OCR process, the font size(s) of the character strings that are present in the periphery of the seal impression, strings of characters concatenated at widths (distances) narrower than such font sizes may each be deemed as one character string. Then, the seal impression related information region extraction processing portion 43 enlarges the seal impression related information region with a rectangular region including such character strings as part of the seal impression related information region, and stores it in the data memory as the seal impression related data 23.

### <Attribute Classification Process>

Details of the process in FIG. 8 of assigning attributes of the character strings included in the seal impression related data 23 (step S804) are described below.

First, the attribute classification processing portion 44 reads the seal impression related data 23, divides the character strings within the seal impression related data 23 line by line, and assigns the attribute of the character string on each line. Specifically, the attribute classification processing portion 44 performs a morphological analysis of the character string on each line using the attribute database 53, and determines an attribute that fits each character string.

In the present embodiment, a description is provided through an example where the attribute database 53 is written in the format “(character pattern):(attribute)”. For example, if “Txxx-xxxx:‘postal code’” is written in the attribute database 53 (where x is an arbitrary number from 0 to 9) and the character string of interest is “T100-0000”, it will be determined that this character string is a match with the format for postal code, and the attribute of postal code will be assigned to this character string. In addition, if “telephone:‘telephone number’” is written in the attribute database 53 and the character string of interest includes the character string “telephone” (or “Tel”) as in “Telephone (03)1234-5678”, the attribute of telephone number is assigned thereto. Further, there are cases where it is specified in the format “‘prefecture name’+‘ward/city/town/village name’:‘address’”. This represents the fact that when a character string with a prefecture name attribute is concatenated with a character string with a ward/city/town/village name attribute, an address attribute is assumed. Thus, attributes are assigned to the respective character strings. The various attribute definitions are mutually independent, and the definitions never collide. In addition, it is assumed that a plurality of patterns representing the same attribute are registered, and that variations in notation can thus be absorbed.

### <Character Substitution Process>

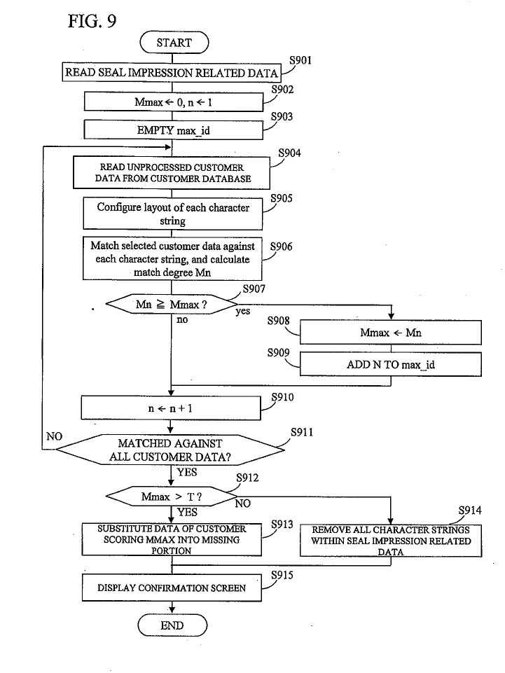

Details of the process in FIG. 8 of substituting characters that are missing due to the overlap with the seal impression are described below with reference to the detailed flowchart shown in FIG. 9. Hereinafter, unless stated otherwise, it is assumed that each step is implemented by the character substitution processing portion.

First, the seal impression related data 23 is read (step S901). Next, variables Mmax and n are initialized (step S902). In addition, variable length array max_id is emptied (step S903).

Then, through the process from step S904 to step S911, the customer that appears to be the best match with respect to the customer information included in the seal impression related data is selected. First, unprocessed customer data is read from the customer database 52 (step S904). Next, the layout of each character string within the seal impression related data 23 is configured (step S905). Specifically, as shown in FIGS. 4D and 4E, the number of characters contained in a region that is missing due to the seal impression and that exists on each character string is estimated. This estimate is based on font size and the size of the blank region. In FIGS. 4D and 4E, the regions where it has been determined that characters should be present are indicated with the symbol “?”.

In addition, the customer data selected in step S904 is matched against the data in the seal impression related data 23 to calculate match degree Mn (step S906). Mn is so calculated as to be greater when there are a large number of matching characters and smaller when there are a large number of non-matching characters or when the number of characters is incongruent. Existing techniques such as alignment score, for example, may be used in the calculation of match degree. In the example of FIG. 4C, since the attributes of postal code, address, customer name, representative, and telephone number are assigned in step S804, of the various information regarding customers shown in FIG. 6, the match degrees with respect to the values of the attributes marked with the dotted line squares (the values marked with the solid line squares) are to be calculated respectively.

Subsequently, it is determined whether or not Mn is equal to or greater than maximum value Mmax (step S907), and if it is greater, Mmax is updated with Mn (step S908). In addition, the value of n at that point, i.e., the ID indicating the customer, is added to max_id (step S909). Here, if the comparison in step S903 is equal, n is added to max_id, whereas if Mn is greater than Mmax in the comparison in step S903, the content held by max_id is discarded, and max_id is made to hold n alone.

Thereafter, n is incremented (step S910). Then, it is determined whether or not matching has been performed with respect to all customer data (step S911), and the process from step S904 to step S910 is repeated if there is any unprocessed customer data. If there is no unprocessed customer data, proceeding to step S912, it is determined whether or not Mmax is greater than threshold value T (step S912). T is a predefined constant and is a threshold value for determining whether or not the matching result is sufficiently plausible.

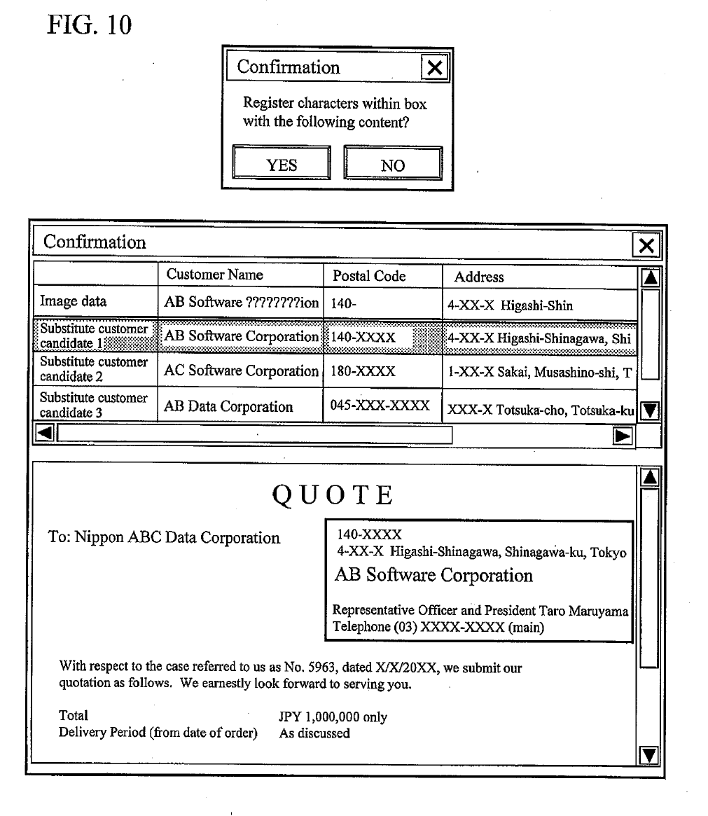

If Mmax is greater than T, the character string that is missing due to the removal of the seal impression is substituted with the customer data scoring Mmax, that is, the customer data corresponding to max_id (step S913). If Mmax is equal to or less than T, it signifies the fact that the match degree is insufficient. Thus, it is determined that there is no corresponding customer data, and all of the character strings within the seal impression related data 23 are removed (step S914). In this case, the central processing unit 10 may, for example, display on the GUI in FIG. 10 the fact that the recognition process failed. Thus, it becomes possible to prevent partially left character strings from becoming noise during subsequent searches.

Finally, a confirmation screen such as that shown in FIG. 10 is displayed, and the user is made to confirm the result of substitution or of removal (step S915). On the upper portion of the screen, the seal impression related data 23 and the customer data corresponding to the customer ID held by max_id are displayed in a table in which they are sorted by attribute value. Thus, the user is able to check how close a match the character strings in the periphery of the seal impression in the image of the document are with the character strings which are values of the respective attributes of the customer that was selected as a candidate for substitution and for whom the match degree was greatest. For example, in the image of the document, the customer name is the character string “AB Sof???????????ration” which has 11 unidentified characters in the middle, and it can be seen that the customer name of candidate 1 is the character string “AB Software Corporation” which is a match therewith.

In addition, on the confirmation screen, of the customers that have been selected as candidates for substitution, the customer specified by the user is displayed in highlight (in the example in FIG. 10, Candidate 1 is shaded). The result of embedding the information on the specified customer into the image is displayed on the lower portion of the screen, and the user is able to check it together with the document image as a whole.

Further, when some other customer displayed in the table on the upper portion of the screen is specified by the user, the specified customer is displayed in highlight, and the customer information displayed with the document image on the lower portion of the screen is simultaneously switched. From such display, the user is able to determine which candidate is suitable for substitution. If the user determines that a candidate suitable for substitution is displayed, he may express agreement by pressing the “yes” button in the dialog. If user agreement is obtained, the processing result is reflected in the customer database. If user agreement is not obtained, processing is cancelled.

### CONCLUSION

In an embodiment of the present invention, with respect to a business document scanned in grayscale such as that shown in FIG. 2, the region of a seal impression is first recognized from within the document by applying the technique of Patent Literature 3, and that region is removed. If the seal impression is affixed in such a manner that it overlaps with character strings, the character strings are also removed therewith. Subsequently, the remaining character strings (the character strings that were not overlapped by the seal impression) are recognized through OCR. As a result, data such as that shown in FIG. 3 is obtained.

Next, as shown in FIG. 4A, a block of character strings present in the periphery of the removed seal impression is cut out as a region having information related to the removed seal impression. Then, the character strings within the region that has been cut out are matched against a database in which information related to those character strings is stored, thereby determining which data the information is related to. In performing matching, the cut out character strings are divided into, for example as in FIG. 4C, such attributes as postal code, address, customer name, and the like, and each attribute information is compared with the database. The database is configured, for example, in such a data format as that shown in FIG. 6. From the results of matching, the data that best matches the information of the respective character strings are determined to be data related to that business document. Then, the characters that are missing due to having removed the seal impression region are substituted with the relevant data in the database.

Through the execution of such processing, it becomes possible to automatically and accurately obtain customer information of a document, even in a case where a seal impression is present within that document in such a manner as to overlap with character strings that contain customer information, by using information surrounding those character strings.

In the present embodiment, a case was described where the character strings that overlapped with a seal impression were character strings that contained customer information. However, the present invention is by no means limited such that character strings that overlap with a seal impression have to be character strings that contain customer information, and processing may be executed with respect to all kinds of character strings. In other words, as long as missing character strings can be extrapolated through a process of matching against a database, the present invention is applicable to all kinds of documents.

In addition, the present invention may also be realized through program code of software that realizes the functions of the embodiment. In this case, a storage medium on which the program code is recorded is supplied to a system or apparatus, and the computer (or CPU or MPU) of that system or apparatus reads the program code stored on that storage medium. Thus, the program code itself that is read from the storage medium would realize the functions of the embodiment described above, and the program code itself, as well as the storage medium storing it, would constitute the present invention. As storage media for supplying such program code, for example, flexible disks, CD-ROMs, DVD-ROMs, hard disks, optical disks, magneto-optical disks, CD-Rs, magnetic tapes, non-volatile memory cards, ROMs and the like may be used.

In addition, based on instructions of program code, an OS (operation system) and the like running on a computer may perform part or all of the actual processing, and the functions of the embodiment described above may be realized through such processing. Further, after the program code read out from the storage medium is written in the memory on the computer, the CPU and the like of the computer may perform part or all of the actual processing based on instructions of that program code, and the functions of the embodiment described above may be realized through such processing.

In addition, program code of software that realizes the functions of the embodiment may be stored on storage means, such as a hard disk, memory or the like of a system or apparatus, or on a storage medium, such as a CD-RW, CD-R or the like, through distribution via a network. At the time of use, the computer (or CPU or MPU) of that system or apparatus may read out and execute the program code stored on the storage means or the storage medium.

### REFERENCE SIGNS LIST

10 Central processing unit
20 Data memory
21 Grayscale image data
22 OCR result data
23 Seal impression related data
30 Input/output devices
31 Keyboard
32 Display device
33 Pointing device
40 Business document processing program
41 Seal impression detection processing portion
42 OCR processing portion
43 Seal impression related information region extraction processing portion
44 Attribute classification processing portion
45 Character substitution processing portion
51 Document database
52 Customer database
53 Attribute database

1. A business document processor that scans a business document and performs recognition processing, the business document processor comprising:
a seal impression detection processing portion configured to detect a seal impression region in a business document inputted in grayscale and removes the seal impression region from the business document;
a seal impression related information extraction processing portion configured to extract, as seal impression related information, character information that is present near the removed seal impression region in the business document from which the seal impression region has been removed, where a portion of characters is unclear due to the seal impression region;
an attribute classification processing portion configured to identify attributes of the seal impression related information that is extracted; and
a character extrapolation processing portion configured to refer to a character string candidate database storing character string candidates and extrapolates, based on the seal impression related information that is classified by the attributes, a character string that overlaps with the seal impression region and is unclear.

2. The business document processor according to claim 1, wherein the character extrapolation processing portion substitutes the character string obtained through extrapolation into a portion that is unclear due to the seal impression region, and registers business document data, into which the character string is substituted, in a document database in a pair with the business document inputted in grayscale.

3. The business document processor according to claim 2, further comprising a display processing portion configured to display on a display portion the business document data into which the character string is substituted, wherein
when there are a plurality of character string candidates for substitution, the display processing portion displays on the display portion a plurality of business document data into which the plurality of candidates are substituted, and
of the plurality of business document data, the character extrapolation processing portion registers, in the document database, business document data selected by a user.

4. The business document processor according to claim 1, wherein
the seal impression related information extraction processing portion extracts, as the seal impression related information, information relating to a customer, and
the character extrapolation processing portion refers to a customer database storing customer information.

5. The business document processor according to claim 3, wherein the character extrapolation processing portion calculates a match degree between information stored in the character string candidate database and the seal impression related information that is classified by the attributes, and takes the information in the character string candidate database to be the character string candidate for substitution when the match degree is greater than a predetermined value.

6. The business document processor according to claim 5, wherein if the match degree is equal to or less than the predetermined value, the character extrapolation processing portion terminates processing without substituting characters into the seal impression region.
